(19) United States
(12) Patent Application Publication
(10) Pub. No.: US 2026/0173161 A1
(43) Pub. Date: Jun. 18, 2026

(54) METHOD AND APPARATUS FOR PERFORMING SMALL DATA TRANSMISSION, AND COMMUNICATION SYSTEM

(71) Applicant: 1FINITY Inc., Kawasaki-shi (JP)

(72) Inventors: Meiyi JIA, Beijing (CN); Guorong LI, Beijing (CN)

(73) Assignee: 1FINITY Inc., Kawasaki-shi (JP)

(21) Appl. No.: 19/532,410

(22) Filed: Feb. 6, 2026

Related U.S. Application Data
(63) Continuation of application No. PCT/CN2023/111846, filed on Aug. 8, 2023.

(51) Int. Cl. H04W 74/0838

(52) U.S. Cl. CPC H04W 74/0838

(57) ABSTRACT

An apparatus for performing small data transmission, applied to a terminal device, includes: first processor circuitry controlling the terminal device, the first processor circuitry configured to perform: initiating small data transmission including Mobile Originated SDT or Mobile Terminated SDT by upper layers of the terminal device; and performing configured grant-based small data transmission when a next valid configured grant occasion fulfils a predetermined condition in the time domain; wherein a valid configured grant occasion is Configured grant resources configured for the small data transmission and corresponds to a synchronization signal block with synchronization signal reference signal received power above a first configured threshold and the synchronization signal block is available.

### CROSS-REFERENCE TO RELATED APPLICATION

This application is a continuation application under 35 U.S.C. 111 (a) of International Patent Application PCT/CN2023/111846 filed on Aug. 8, 2023, and designated the U.S., the entire contents of which are incorporated herein by reference.

### TECHNICAL

Embodiments of the present disclosure relate to the field of communication technologies.

### BACKGROUND

Small Data Transmission (SDT) process allows a radio resource to control transmission of data and/or signaling in an inactive (RRC_INACTIVE) state, wherein the RRC_INACTIVE state refers to a state of not entering radio resource control connection (RRC_CONNECTED).

In new radio (NR), until version 16 (Rel-16), the RRC_INACTIVE state does not support data transmission, thus a terminal equipment (such as a UE) needs to needs to restore connection first, that is, switches to the RRC_CONNECTED state to perform data transmission of downlink/terminal equipment termination (DL/MT) and uplink/terminal equipment orientation (UL/MO). This means that even for infrequent small data transmission, it is necessary to establish/restore connection and then release into an INACTIVE state transition, which leads to energy consumption and signaling overhead. Infrequent small data transmission includes businesses of instant messaging services (such as whatsapp, QQ, and wechat), heartbeat business or keep-alive business of instant messaging or email (IM/e-mail) clients and other APPs, push notifications of various applications, businesses (such as periodic positioning information) of wearable devices, and sensors (for example, an industrial radio sensor network transmit temperature/pressure readings periodically or in an event-triggered manner) and smart electric meters (or networks) periodically transmit electric meter readings, etc.

Not only for network performance and efficiency, but also for UE battery performance, signaling overhead of INACTIVE UEs to perform small data transmission is a main problem for more UEs in NR and becomes a key problem. Basically, any device that has occasional small data packets in the INACTIVE state benefits from the small data transmission in the INACTIVE state. It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

Inventor of the present disclosure finds that for related arts, how to perform small data transmission at a more reasonable occasion so as to improve reliability of the small data transmission is a problem that needs to be perfected.

For at least one of the above problems or other similar problems, the embodiments of the present disclosure provide a method and an apparatus for performing small data transmission, and a communication system.

According to one aspect of the embodiments of the present disclosure, an apparatus for performing small data transmission is provided, applied to a terminal equipment, the apparatus including a first processing unit configured to control the terminal equipment to enable the terminal equipment to perform the following operations:
initiating small data transmission (SDT); and
performing configured grant-based small data transmission (CG-SDT) in a case where a next valid configured grant occasion (CG occasion) fulfils a predetermined condition in time domain.

According to another aspect of the embodiments of the present disclosure, an apparatus for performing small data transmission is provided, applied to a terminal equipment, the apparatus including a second processing unit configured to control the terminal equipment to enable the terminal equipment to perform the following operations:
initiating small data transmission (SDT); and
performing configured grant-based small data transmission (CG-SDT) in a case where a next configured grant occasion (CG occasion) fulfils a predetermined condition in time domain,
the fulfilling the predetermined condition in the time domain includes:
there is no an available random access occasion (RA occasion) between an initiation of the small data transmission (SDT) and the next configured grant occasion (CG occasion), or, a time gap between the next configured grant occasion (CG occasion) and an available random access occasion (RA occasion) is less than a second configured offset.

One of advantageous effects of the embodiments of the present disclosure is: to be able to set a more reasonable occasion for execution of small data transmission, thereby improving reliability of the small data transmission.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system of the present disclosure;

FIG. 2 is a schematic diagram of a random access-based small data transmission process during RRC inactivity;

FIG. 3 is a schematic diagram of a process of RACH-based small data transmission or of executing a RACH process to enter an RRC connected state;

FIG. 4 is a schematic diagram of a configured grant-based small data transmission process during RRC inactivity;

FIG. 5 is a schematic diagram of initiating an SDT;

FIG. 6 is a schematic diagram of interlayer interaction of a terminal equipment and initiation evaluation of MT-SDT;

FIG. 7 is a schematic diagram of a time gap between initiation of the SDT process and a next CG-SDT occasion in condition 2);

FIG. 8 is a schematic diagram of a method for performing small data transmission in the embodiments of a first aspect;

FIG. 9 is another schematic diagram of a time gap between initiation of the SDT process and a next CG-SDT occasion in condition 2);

FIG. 10 is a schematic diagram of a method for performing small data transmission in the embodiments of a second aspect;

FIG. 11 is a schematic diagram of an apparatus for performing small data transmission in the embodiments of a third aspect;

FIG. 12 is a schematic diagram of an apparatus for performing small data transmission in the embodiments of a fourth aspect;

FIG. 13 is a schematic diagram of a method for performing small data transmission in the embodiments of a fifth aspect;

FIG. 14 is a schematic diagram of an apparatus for performing small data transmission in the embodiments of a sixth aspect; and

FIG. 15 is a schematic diagram of an electronic device in the embodiments of a seventh aspect.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as New Radio (NR), Long Term Evolution (LTE), LTE-Advanced (LTE-A), Wideband Code Division Multiple Access (WCDMA), High-Speed Packet Access (HSPA).

And, communication between devices in a communication system may be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: an Integrated Access and Backhaul node (IAB-node), a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC).

The base station may include but be not limited to: node B (NodeB or NB), evolution node B (eNodeB or eNB) and a 5G base station (gNB), and may further includes Remote Radio Head (RRH), Remote Radio Unit (RRU), a relay or a low power node (such as femeto, and pico). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment may be fixed or mobile, and may also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above.

In the following description, without causing confusion, the terms “uplink control signal” and “Uplink Control Information (UCI)” or “Physical Uplink Control Channel (PUCCH)” are interchangeable, and the terms “uplink data signal” and “uplink data information” or “Physical Uplink Shared Channel (PUSCH)” are interchangeable.

The terms “downlink control signal” and “Downlink Control Information (DCI)” or “Physical Downlink Control Channel (PDCCH)” are interchangeable, and the terms “downlink data signal” and “downlink data information” or “Physical Downlink Shared Channel (PDSCH)” are interchangeable.

Moreover, transmitting or receiving a PUSCH can be understood as transmitting or receiving uplink data carried by the PUSCH, transmitting or receiving a PUCCH can be understood as transmitting or receiving uplink information carried by the PUCCH, transmitting or receiving a PRACH can be understood as transmitting or receiving a preamble carried by the PRACH; an uplink signal may include an uplink data signal and/or an uplink control signal, etc., or may also be referred to as UL transmission or uplink information or uplink channel. Transmitting an uplink transmission on an uplink resource can be understood as transmitting the uplink transmission by using the uplink resource. Similarly, downlink data/signals/channels/information may be understood accordingly.

In the embodiments of the present disclosure, upper layer signaling may be e.g. radio resource control (RRC) signaling; for example, is called an RRC message, for example includes an MIB, system information, and a dedicated RRC message; or is called an RRC information element (RRC IE). The upper layer signaling, for example, may further be Medium Access Control (MAC) signaling; or called a MAC control element (MAC CE). However, the present disclosure is not limited thereto.

Scenarios of the embodiments of the present disclosure are described through the following examples, however the present disclosure is not limited thereto.

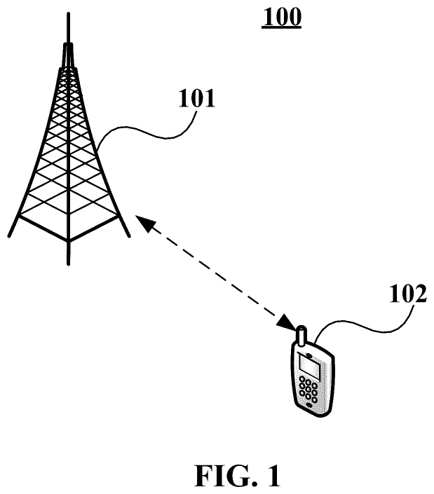

FIG. 1 is a schematic diagram of a communication system in the present disclosure, schematically describes situations by taking a terminal equipment and a network device as examples, as shown in FIG. 1, a communication system 100 may include a network device 101 and a terminal equipment 102 (for the sake of simplicity, FIG. 1 makes the description only by taking one terminal equipment as an example).

In the embodiments of the present disclosure, existing or further implementable services may be carried out between the network device 101 and the terminal equipment 102. For example, these services include but are not limited to: enhanced Mobile Broadband (eMBB), massive Machine Type Communication (mMTC), and Ultra-Reliable and Low-Latency Communication (URLLC).

The terminal equipment 102 may transmit data to the network device 101, for example, using a grant (such as a configured grant) or grant-free transmission mode. Under a grant mode, the network device 101 may receive the data transmitted by one or more terminal equipments 102 in a grant, and feed back information to the terminal equipment(s) 102, such as acknowledgment ACK/non-acknowledgment ACK information, or indicate a new grant to the terminal equipment(s) 102, the terminal equipment(s) 102 may confirm ending a transmission process, or may further perform new data transmission, or may perform data retransmission, according to the feedback information or the new grant. For the grant-free transmission mode, the terminal equipment may transmit new data on a configured grant or perform retransmission.

Key factors of small data transmission (SDT) in NR, i.e., an INACTIVE state, 2-step/4-step random access and configured grant type-1, have all been defined as a part of Rel-15 and Rel-16. Therefore, it is ensured that small data transmission in the INACTIVE state of NR may be based on these factors.

SDT is enabled on a radio bearer, SDT that may be initiated at a mobile terminal, i.e., SDT initiated by a UE and/or terminated at the mobile terminal in the case of Mobile Originated SDT (MO-SDT), i.e., in case the of Mobile Terminated small data transmission (MT-SDT), is initiated by the network device. The network device may enable MO-SDT and/or MT-SDT in a cell. MO-SDT is initiated by UE only if the UL data volume waiting to be transmitted on all radio carriers with SDT activated is less than a configured value, DL RSRP is greater than a configured threshold, and a valid SDT resource is available. When DL data waits for transmission of a radio bearer configured with SDT, MT-SDT is initiated by a network using an indication transmitted to the UE in a paging message; based on this indication, the UE initiates MT-SDT only if the DL RSRP is greater than the configured threshold.

The SDT process is initiated using a transmission on a random access channel (RACH) or a Type 1 configured grant (Type 1 CG) resource, wherein the RACH may be configured by system information, and the Type 1 CG resource may be configured by dedicated signaling in a radio resource control release (RRCRelease). For RACH and CG, an SDT resource may be configured on an initial partial bandwidth (initial BWP), or on a non supplementary uplink (NUL) carrier and/or on a supplementary uplink (SUL) carrier. A CG resource of SDT is only valid in a primary cell (PCell) of a UE when an RRCRelease carrying a suspension indication is received, and is associated with one or more synchronization signal blocks (SSBs/PBCH Blocks). SDT on the RACH does not support contention-free random access (CFRA). If MT-SDT on the RACH is initiated, the UE only uses a RACH that is not configured with SDT (i.e., RACH configured for MO-SDT).

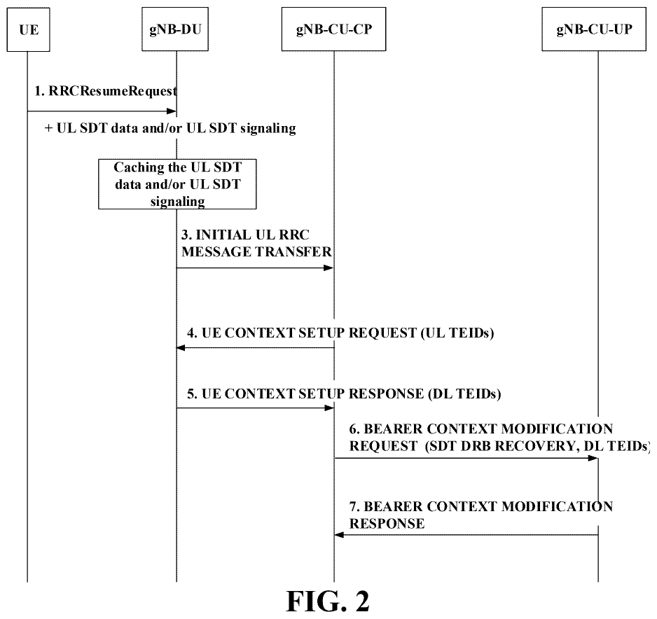

FIG. 2 is a schematic diagram of a random access-based small data transmission process during RRC inactivity. As shown in FIG. 2, the process includes the following operations:
Operation 1. An RRC inactive UE transmits an RRCResumeRequest message and transmits UL SDT data and/or UL SDT signaling;
Operation 2. A gNB-DU (distributed unit) caches the UL SDT data and/or UL SDT signaling;
Operation 3. The gNB-DU includes RRCResumeRequest and SDT access indications in an INITIAL UL RRC MESSAGE TRANSFER message that is not associated with the UE, and transfers them to a gNB-CU-CP (control plane); this gNB-DU may further provide SDT assistance information;
Operation 4 and operation 5. The gNB-CU-CP transmits a UE CONTEXT SETUP REQUEST message including stored F1 UL TEIDs to create a UE context in the gNB-DU; the gNB-DU response includes the UE CONTEXT SETUP RESPONSE message including F1 DL TEIDs assigned for DRBs (carrying user data); if there is any UL SDT data, it is transferred to the gNB-CU-UP (user plane), and if there is any UL signaling, it is transferred to the gNB-CU-CP via a UL RRC MESSAGE TRANSFER message, wherein any uplink non-access stadium protocol data unit (UL NAS PDU) is transmitted to AMF (Access and Mobility Management Function);
   Note 1: in a case where a full UE context is obtained from another gNB-CU-CP, this gNB-CU-CP first sets up a UE context in the gNB-CU-UP via a bearer context setup process, and obtains F1-U UL TEIDs before operation 4. The BEARER CONTEXT SETUP REQUEST message may include an indication for initiating a non-SDT bearer. Under this circumstance, the BEARER CONTEXT MODIFICATION REQUEST message in operation 6 does not include a resume indication for SDT DRBs;
   Note 2: in a case where only part of the UE context of the SDT including F1-U UL TEIDs is obtained from another gNB-CU-CP, this gNB-CU-CP uses those F1-U UL TEIDs in steps 4-5 and does not perform subsequent operations 6-7. The F1-U DL TEIDs received from the gNB-DU in operation 5 should be transferred to another gNB-CU-CP, for transmission of DL SDT data. Furthermore, if there is UL SDT data transferred from the gNB-DU to the gNB-CU-UP of another gNB-CU-CP that acquires part of the context, if there is UL signaling, it is transferred from the gNB-CU-CP to another gNB-CU-CP (the final serving gNB-CU-CP) via an XnAP RRC TRANSFER message;
   Note 3: if received before resuming the SDT bearer, other gNB-CU-UPs may need to cache the UL SDT data;
Operation 6. The gNB-CU-CP transmits a BEARER CONTEXT MODIFICATION REQUEST message including a resume indication for SDT DRBs; the gNB-CU-CP further includes the F1-U DL TEIDs received from the gNB-DU in operation 5; and
Operation 7. The gNB-CU-UP responds to the BEARER CONTEXT MODIFICATION RESPONSE message.
   Note 4: when SDT transmission is completed, the gNB-CU transmits a UE CONTEXT RELEASE COMMAND message to the gNB-DU. If CG-SDT is (re) configured, the gNB-CU may request the gNB-DU to retain CG-SDT configuration and resources in the UE CONTEXT RELEASE COMMAND message.

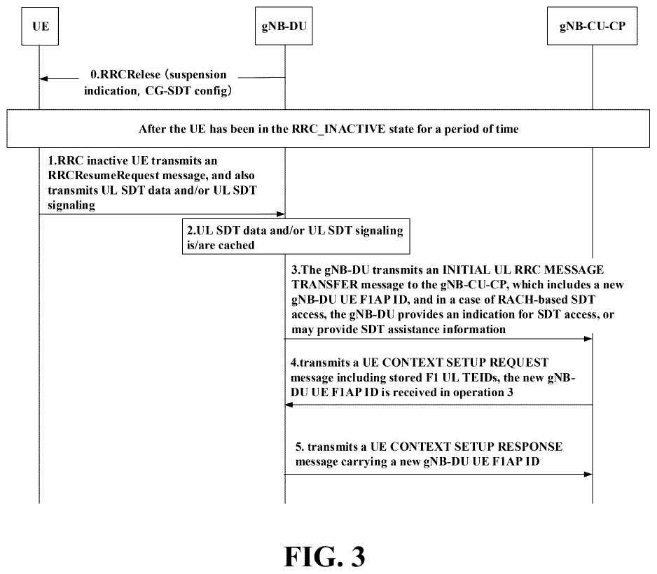

In some cases, the UE has CG-SDT resource configuration but decides to perform RACH-based small data transmission in an RRC inactive state or to execute a RACH process to enter an RRC connected state. FIG. 3 is a schematic diagram of a process of RACH-based small data transmission or of executing a RACH process to enter an RRC connected state. As shown in FIG. 3, the process includes the following operations:
Operation 1. An RRC inactive UE transmits an RRCResumeRequest message. If the UE decides to perform a RACH-based SDT process, it further transmits UL SDT data and/or UL SDT signaling;
Operation 2. The gNB-DU caches the UL SDT data and/or UL SDT signaling;
Operation 3. The gNB-DU transmits an INITIAL UL RRC MESSAGE TRANSFER message to the gNB-CU-CP, which includes a new gNB-DU UE F1AP ID, and in a case of RACH-based SDT access, the gNB-DU provides an indication for SDT access, or may provide SDT assistance information;
Operation 4. The gNB-CU-CP transmits a UE CONTEXT SETUP REQUEST message including stored F1 UL TEIDs, the new gNB-DU UE F1AP ID is received in operation 3;

In a case where the gNB-DU is a gNB-DU that transmits an RRCRelease message carrying the CG-SDT resource configuration to the UE, in an Old CG-SDT Session Info IE of the UE CONTEXT SETUP REQUEST message, the gNB-CU-CP also includes an old gNB-DU UE F1AP ID and an old gNB-CU UE F1AP ID;

In a case where the gNB-CU-CP is a gNB-CU-CP that generates the RRCRelease message carrying the CG-SDT resource configuration but the gNB-DU is not an old gNB-DU that transmits the RRCRelease message to the UE, the gNB-CU-CP initiates a UE Context Release process by transmitting a UE CONTEXT RELEASE COMMAND message to the old gNB-DU;

In a case where the UE accesses a gNB other than the final serving gNB, when a RETRIEVE UE CONTEXT REQUEST message from the receiving gNB-CU-CP is received, a final serving gNB-CU-CP initiates a UE Context Release process by transmitting the UE CONTEXT RELEASE COMMAND message to a final serving gNB-DU; and
Operation 5. The gNB-DU transmits a UE CONTEXT SETUP RESPONSE message carrying a new gNB-DU UE F1AP ID. In a case where the old gNB-DU UE F1AP ID is received within the Old CG-SDT Session Info IE in operation 4, the gNB-DU obtains the stored CG-SDT resource configuration and UE context based on the Old CG-SDT Session Info IE, if any, and is associated with the new gNB-DU UE F1AP ID.

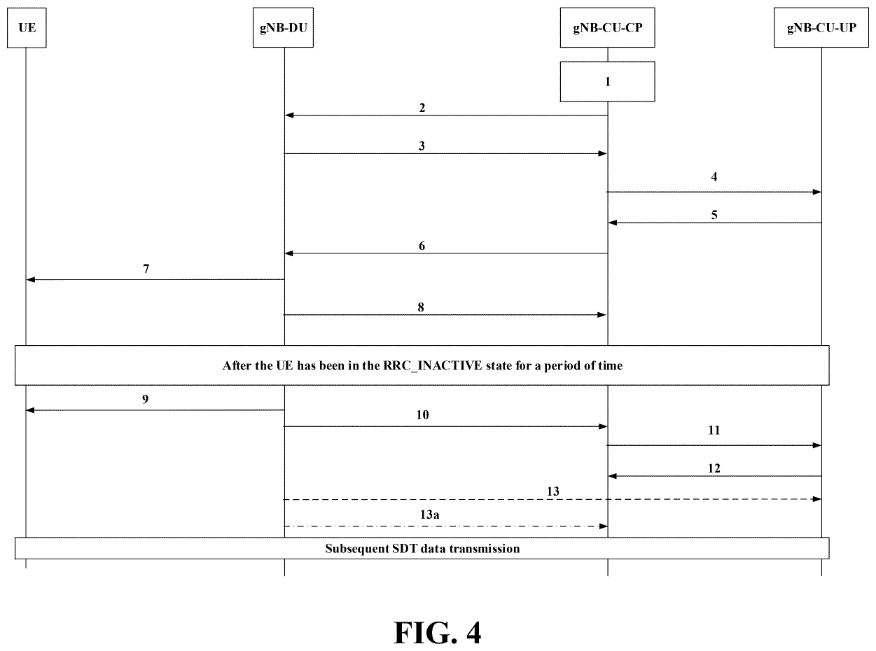

FIG. 4 is a schematic diagram of a configured grant-based small data transmission process during RRC inactivity. As shown in FIG. 4, the process includes the following operations:
Operation 1. The gNB-CU decides to enable a UE to enter an RRC INACTIVE state;
Operation 2. The gNB-CU-CP decides to configure CG-SDT and transmits a UE CONTEXT MODIFICATION REQUEST message, which includes a query indication for CG-SDT related resource configuration associated with SDT radio bearer information;
Operation 3. The gNB-DU transmits a UE CONTEXT MODIFICATION RESPONSE message, which includes the CG-SDT related resource configuration of a requested SDT radio bearer in a DU to CU RRC Information IE;
Operation 4. The gNB-CU-CP transmits BEARER CONTEXT MODIFICATION REQUEST carrying a suspension indication to the gNB-CU-UP;
Operation 5. The gNB-CU-UP transmits BEARER CONTEXT MODIFICATION RESPONSE to the gNB-CU-CP;
Operation 6. The gNB-CU-CP transmits a UE CONTEXT RELEASE COMMAND message to the gNB-DU, which includes an RRCRelease message transmitted to the UE, wherein the suspended configuration carries CG-SDT information. When the UE is entering the RRC INACTIVE state with an explicit CG-SDT kept indicator, the gNB-CU notifies the gNB-DU to retain SDT RLC configuration, F1-U tunnels, CG resources of SDT associated with and stored by a F1AP UE;
Operation 7. The gNB-DU transmits an RRCRelease message to the UE;
Operation 8. The gNB-DU transmits a UE CONTEXT RELEASE COMPLETE message.

When the UE enters RRC INACTIVE, the gNB-DU retains the SDT RLC configuration, F1-U tunnels, CG resources of SDT associated with and stored by a F1AP UE. The gNB-DU further stores C-RNTIs, CS-RNTIs and which bearers are CG-SDT bearers; After the UE has been in the RRC INACTIVE state for a period of time
Operation 9. The UE decides to perform a CG-based SDT process, transmits an RRCResumeRequest message and simultaneously transmits UL SDT data/UL NAS PDUs;
Operation 10. The gNB-DU transmits a UL RRC MESSAGE TRANSFER message, which include the RRCResumeRequest message, to indicate that the access is due to CG-SDT;
Operations 11/12. The gNB-CU-CP initiates a BEARER CONTEXT MODIFICATION process to resume SDT DRBs; and
Operation 13-operation 13a. The gNB-DU transmits the number of UL SDTs (if any) to the gNB-CU-UP, and/or, transmits UL signaling (if any) to the gNB-CU-CP via a UL RRC MESSAGE TRANSFER message, wherein any UL NAS PDU is transmitted to AMF.
   Note: when SDT transmission is completed, the gNB-CU transmits a UE CONTEXT RELEASE COMMAND message to the gNB-DU. If CG-SDT is reconfigured, the gNB-CU may request the gNB-DU to retain CG-SDT configuration and resources in the UE CONTEXT RELEASE COMMAND message.

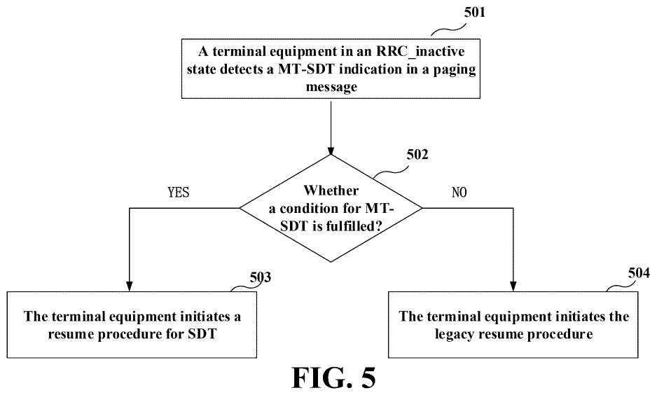

FIG. 5 is a schematic diagram of initiating an SDT. As shown in FIG. 5, the process for initiating an SDT includes the following operations:
Operation 501. A terminal equipment in an RRC_inactive state detects a MT-SDT indication in a paging message;
Operation 502. The terminal equipment determines whether a condition for MT-SDT is fulfilled. If it is fulfilled (i.e., determined as “yes”), proceeding to operation 503, otherwise, proceeding to operation 504;
Operation 503. The terminal equipment initiates an RRC resume procedure for SDT (UE initiates the resume procedure for SDT); and
Operation 504. The terminal equipment initiates an RRC resume procedure (UE initiates the legacy resume procedure), for example enters a connected state. The RRC resume procedure is performed according to existing RRC resume procedures.

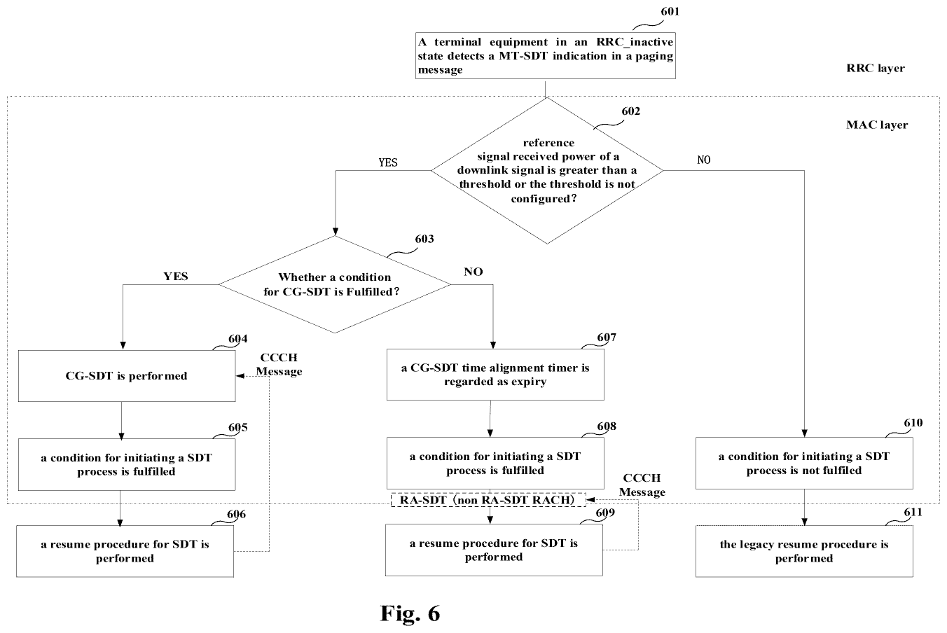

FIG. 6 is a schematic diagram of interlayer interaction of a terminal equipment and initiation evaluation of MT-SDT. FIG. 6 includes the following operations:
Operation 601. A terminal equipment in an RRC_inactive state detects a MT-SDT indication in a paging message;
Operation 602. It is determined whether the reference signal received power of a downlink reference signal is greater than a threshold or the threshold is not configured (RSRP of the DL PL reference is higher than Threshold or Threshold is not configured), if it is determined as “yes”, proceeding to operation 603, otherwise, proceeding to operation 610;
Operation 603. It is determined whether a condition for CG-SDT is fulfilled (Are conditions for CG-SDT fulfilled?), if determined as “yes”, proceeding to operation 604, otherwise, proceeding to operation 607;
Operation 604. configured grant-based small data transmission (CG-SDT) is performed; Operation 605. the condition for initiating the SDT process is fulfilled;
Operation 606. the RRC resume procedure for SDT is initiated, wherein a cause is MT-SDT, moreover, a common control channel message (CCCH message) is submitted to a media access control layer (MAC layer) to perform the configured grant-based small data transmission (CG-SDT), corresponding to operation 503 in FIG. 5;
Operation 607. a CG-SDT timing alignment timer (TAT) is regarded as expiry; Operation 608. the condition for initiating the SDT process is fulfilled;
Operation 609. the RRC resume procedure for SDT is initiated, wherein a cause is MT-SDT, moreover, submitting a common control channel message (CCCH message) to a media access control layer (MAC layer) to perform a random access-based small data transmission (RA-SDT) (non RA-SDT RACH), corresponding to operation 503 in FIG. 5;
Operation 610. the condition for initiating the SDT process is not fulfilled;
Operation 611. an RRC resume procedure (the legacy resume procedure) is performed, wherein a cause is mobile terminated access (MT-access), moreover, a common control channel message (CCCH message) is transmitted to a media access control layer (MAC layer) to perform random access (legacy RA), i.e., entering a connected state, corresponding to operation 504 in FIG. 5. The RRC resume procedure is performed according to existing RRC resume procedures, and the random access procedure is performed according to existing random access procedures.

In operation 603 of FIG. 6, the condition for CG-SDT may include:
1) CG-SDT (such as type-1 CG) is configured on a selected UL carrier, and a timing advance (TA) of the CG-SDT in a first available CG occasion of initial CG-SDT transmission carrying the CCCH message is valid; or
2) a time gap between initiation of the SDT process and a next CG-SDT occasion (opportunity) is less than an offset, the offset for example is cg-SDT-MaxDurationToNext-CG-Occasion (if configured); or
3) At least one SSB whose synchronization signal reference signal received power (SS-RSRP) configured for CG-SDT is greater than cg-SDT-RSRP-ThresholdSSB is available.

In each embodiments of the present disclosure: the SDT and the SDT process have the same meaning, and the CG-SDT occasion has the same meaning as the CG occasion.

### Embodiments of a First Aspect

In operation 603 of FIG. 6, the condition 2) for CG-SDT takes into account a time gap between initiation of the SDT process and a next CG-SDT occasion, to ensure that a terminal is able to respond to network paging timely.

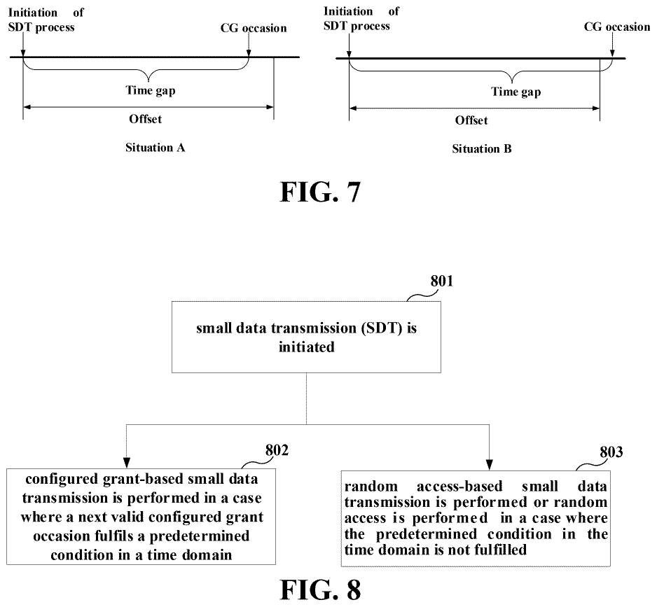

FIG. 7 is a schematic diagram of a time gap between initiation of the SDT process and a next CG-SDT occasion in condition 2), in which the CG-SDT occasion and the CG occasion have the same meaning.

In the situation A of FIG. 7, a time gap between initiation of the SDT process and a next CG-SDT occasion is less than an offset, wherein the offset e.g. is cg-SDT-MaxDurationToNext-CG-Occasion, thus CG-SDT may be performed.

In the situation B of FIG. 7, the time gap between initiation of the SDT process and a next CG-SDT occasion is greater than an offset, wherein the offset e.g. is cg-SDT-MaxDurationToNext-CG-Occasion, thus CG-SDT is not performed.

In addition, the condition 3) takes into account SS-RSRP of SSBs of the CG-SDT, to ensure the quality of a radio link that initiates the SDT.

Inventor of the present disclosure finds that in a case where condition 2) and condition 3) are independent of each other, that is, the CG occasion fulfilling condition 2) is not correlated with SSBs fulfilling condition 3), which means that when CG-SDT is initiated, a CG occasion transmitted on a selected SSB may not respond to network paging timely (for example, although this CG occasion fulfils condition 2) but does not fulfill condition 3), thereby leading to failure to deliver downlink data timely.

In order to solve the above problem, the embodiments of a first aspect of the present disclosure provide a method for performing small data transmission, the method being applicable to a terminal equipment, such as the terminal equipment 102 in FIG. 1.

FIG. 8 is a schematic diagram of a method for performing small data transmission in the embodiments of a first aspect. As shown in FIG. 8, the method for performing small data transmission includes:
operation 801, small data transmission (SDT) is initiated; and
operation 802, configured grant-based small data transmission (CG-SDT) is performed in a case where a next valid configured grant occasion (CG occasion) fulfils a predetermined condition in time domain.

According to the method in the embodiments of the first aspect, for a next configured grant occasion (CG occasion) after initiating small data transmission (SDT), there are both a time-domain requirement and a validity requirement, thereby being able to ensure that a CG occasion transmitted on a selected SSB is able to respond to paging of a network device timely, thus improving reliability and efficiency of the small data transmission.

In some embodiments, for the operation of initiating small data transmission in operation 801, relevant technologies may be referred to. The operation of initiating small data transmission (SDT) in operation 801 may be called initiation of SDT, the initiation of SDT may include at least one of the following operations:
a media access control (MAC) layer of the terminal equipment receiving an indication for initiating small data transmission (SDT) from a radio resource control (RRC) layer;
a upper layer of the terminal equipment indicating initiating small data transmission (SDT), i.e., initiating MT-SDT;
a media access control (MAC) layer of the terminal equipment evaluating or determining whether a condition for initiating small data transmission (SDT) is fulfilled; or
a media access control (MAC) layer of the terminal equipment evaluating or determining whether a condition for performing configured grant-based small data transmission (CG-SDT) is fulfilled.

In some embodiments, the valid configured grant occasion (CG occasion) in operation 802 includes:
configured grant (CG) resources configured for the small data transmission (SDT); and/or a synchronization signal block (SSB/PBCH block) associated with the configured grant (CG) resources is available, wherein association between the configured grant (CG) resources and the synchronization signal block (SSB) may be configured by a network device (such as the network device 101 in FIG. 1); and/or
synchronization signal reference signal received power (SS-RSRP) of the synchronization signal block (SSB) associated with the configured grant (CG) resources is above a first configured threshold, wherein association between the configured grant (CG) resources and the synchronization signal block (SSB) may be configured by a network device (such as the network device 101 in FIG. 1); the first configured threshold e.g. may be cg-SDT-RSRP-ThresholdSSB or a reference signal received power (RSRP) threshold that is configured for mobile terminated small data transmission (MT-SDT) and is different from cg-SDT-RSRP-ThresholdSSB.

In some embodiments, the fulfilling the predetermined condition in the time domain in operation 802 includes fulfilling at least one of the following condition 1 and condition 2:
condition 1, a time gap between an initiation of the small data transmission (SDT) and the next valid configured grant occasion (CG occasion) is less than a first configured offset, for example the first configured offset includes cg-SDT-MaxDuration ToNext-CG-Occasion, or the first configured offset includes a time offset different from cg-SDT-MaxDurationToNext-CG-Occasion;
condition 2, there is no an available random access occasion (RA occasion) between an initiation of the small data transmission (SDT) and the next valid configured grant occasion (CG occasion) (i.e., there is no available RA occasion until a next valid CG occasion), or, a time gap between the next valid configured grant occasion (CG occasion) and an available random access occasion (RA occasion) is less than a second configured offset, wherein the RA occasion precedes the CG occasion, in addition, the second configured offset includes cg-SDT-MaxDurationToNext-CG-Occasion, or the second configured offset includes a time offset different from cg-SDT-MaxDuration ToNext-CG-Occasion.

In some embodiments, in the condition 2, if the available random access occasion (RA occasion) is for 2-step random access (2-step RA), the available random access occasion (RA occasion) may be:
a random access occasion for transmitting a random access preamble (RA preamble), for example the random access occasion (RA occasion) is a random access occasion (RA occasion) associated with a first synchronization signal block (SSB), a synchronization signal reference signal received power (SS-RSRP) of the first SSB is higher than a configured second threshold; or
an available physical uplink shared channel occasion (PUSCH occasion), for example the available physical uplink shared channel occasion (PUSCH occasion) is used for transmitting MsgA, and the available physical uplink shared channel occasion (PUSCH occasion) is associated with the available random access occasion (RA occasion); or
a later one of the random access occasion for transmitting the random access preamble (RA preamble) and the available physical uplink shared channel occasion (PUSCH occasion).

In some embodiments, in the condition 2, if the available random access occasion (RA occasion) is for 4-step random access (4-step RA), the available random access occasion (RA occasion) may be: a random access occasion (RA occasion) associated with a second synchronization signal block (SSB), a synchronization signal reference signal received power (SS-RSRP) of the second SSB is higher than a configured third threshold.

Through the condition 2, CG-SDT may be performed in a case where the CG occasion occurs earlier than the RA occasion, thereby enabling the terminal equipment to respond to paging of the network device timely.

In some embodiments, as shown in FIG. 8, the method may further include:
operation 803, in a case where the predetermined condition in the time domain is not fulfilled, random access-based small data transmission (RA-SDT) is performed or random access is performed.

In operation 803, that the predetermined condition in the time domain is not fulfilled may include: the condition 1 is not fulfilled; or the condition 2 is not fulfilled; or both the condition 1 and the condition 2 are not fulfilled.

In operation 803, that random access-based small data transmission (RA-SDT) is performed includes: transmitting a resume request message, wherein a resume cause of the resume request message is mobile terminated small data transmission (MT-SDT).

In operation 803, random access is performed, which may be that legacy random access (legacy RA) is performed, for example including: transmitting a resume request message, wherein a resume cause of the resume request message is mobile terminated access (MT-access).

### Embodiments of a Second Aspect

In operation 603 of FIG. 6, the condition 2) for CG-SDT takes into account a time gap between initiation of the SDT process and a next CG-SDT occasion.

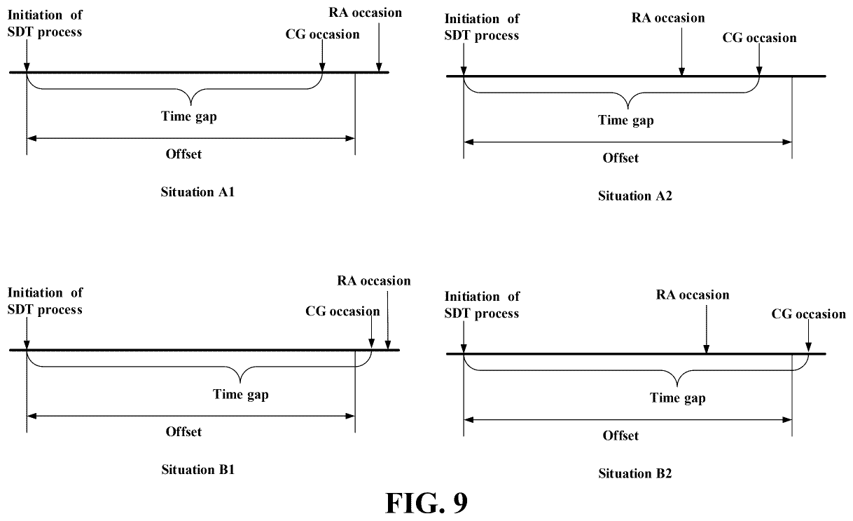

FIG. 9 is another schematic diagram of a time gap between initiation of the SDT process and a next CG-SDT occasion in condition 2). In FIG. 9, the RA occasion is also shown, in which the CG-SDT occasion and the CG occasion have the same meaning.

In the situation A1 of FIG. 9, a time gap between initiation of the SDT process and a next CG-SDT occasion is less than an offset, wherein the offset e.g. is cg-SDT-MaxDurationToNext-CG-Occasion, thus CG-SDT may be performed according to condition 2). A next RA occasion comes after the CG-SDT occasion.

In the situation A2 of FIG. 9, a time gap between initiation of the SDT process and a next CG-SDT occasion is less than an offset, wherein the offset e.g. is cg-SDT-MaxDurationToNext-CG-Occasion, thus CG-SDT may be performed according to condition 2). A next RA occasion comes before the CG-SDT occasion.

In the situation B1 of FIG. 9, a time gap between initiation of the SDT process and a next CG-SDT occasion is greater than an offset, wherein the offset e.g. is cg-SDT-MaxDurationToNext-CG-Occasion, thus CG-SDT is not performed according to condition 2), but RA-SDT or legacy RA is performed using the next RA occasion. A next RA occasion comes after the CG-SDT occasion.

In the situation B2 of FIG. 9, a time gap between initiation of the SDT process and a next CG-SDT occasion is greater than an offset, wherein the offset e.g. is cg-SDT-MaxDurationToNext-CG-Occasion, thus CG-SDT is not performed according to condition 2), but RA-SDT or legacy RA is performed using the next RA occasion. The next RA occasion comes before the CG-SDT occasion, that is, the next RA occasion appears between the initiation of the SDT process and the next CG-SDT occasion.

Inventor of the present disclosure finds that as shown in FIG. 9, in the case of performing CG-SDT according to condition 2), there exists the problem that a terminal equipment cannot respond to paging of a network device timely.

For example, in the situation A2 of FIG. 9, although the RA occasion is before the CG-SDT occasion, according to condition 2), the terminal equipment performs CG-SDT; if the terminal equipment uses the RA occasion to perform RA-SDT, it is able to respond to paging of a network device earlier.

For another example, in the situation B1 of FIG. 9, although the CG-SDT occasion is before the RA occasion, according to condition 2), the terminal equipment does not perform CG-SDT but performs RA-SDT or legacy RA; and if the terminal equipment uses the CG-SDT occasion to perform CG-SDT, it is able to respond to paging of a network device earlier.

In order to solve the above problem, the embodiments of the second aspect of the present disclosure provide a method for performing small data transmission, the method being applicable to a terminal equipment, such as the terminal equipment 102 in FIG. 1.

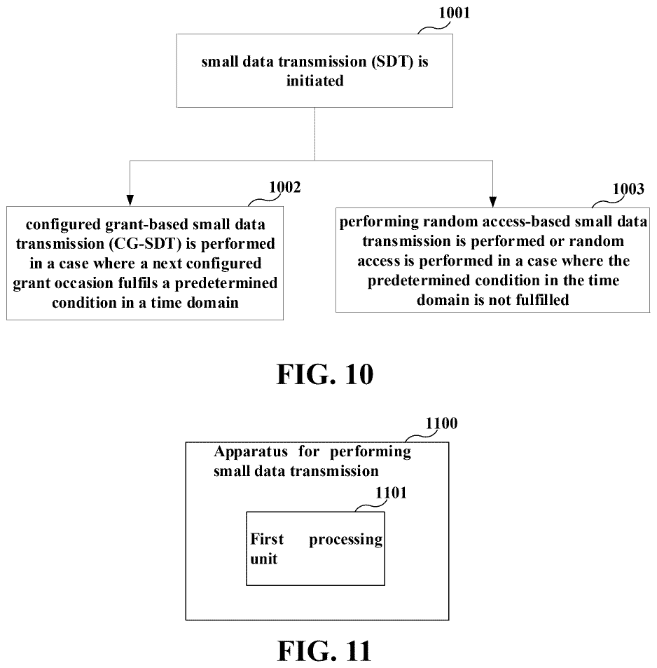

FIG. 10 is a schematic diagram of a method for performing small data transmission in the embodiments of a second aspect. As shown in FIG. 10, the method for performing small data transmission includes:
operation 1001, small data transmission (SDT) is initiated; and
operation 1002, configured grant-based small data transmission (CG-SDT) is performed in a case where a next configured grant occasion (CG occasion) fulfils a predetermined condition in time domain, wherein the fulfilling the predetermined condition in the time domain includes: there is no an available random access occasion (RA occasion) between an initiation of the small data transmission (SDT) and the next configured grant occasion (CG occasion), or, a time gap between the next configured grant occasion (CG occasion) and an available random access occasion (RA occasion) is less than a second configured offset.

According to the method in the embodiments of the second aspect, it is able to respond to paging of a network device earlier.

In some embodiments, for the operation of initiating small data transmission in operation 1001, relevant technologies may be referred to. The operation of initiating small data transmission (SDT) in operation 1001 may be called initiation of SDT, the initiation of SDT may include at least one of the following operations:
a media access control (MAC) layer of the terminal equipment receiving an indication for initiating small data transmission (SDT) from a radio resource control (RRC) layer;
a upper layer of the terminal equipment indicating initiating small data transmission (SDT), i.e., initiating MT-SDT;
a media access control (MAC) layer of the terminal equipment evaluating or determining whether a condition for initiating small data transmission (SDT) is fulfilled; or
a media access control (MAC) layer of the terminal equipment evaluating or determining whether a condition for performing configured grant-based small data transmission (CG-SDT) is fulfilled.

In some embodiments, the fulfilling the predetermined condition in the time domain in operation 1002 includes fulfilling the following condition 2, or fulfilling both the following condition 1 and condition 2.
condition 1, a time gap between an initiation of the small data transmission (SDT) and the next configured grant occasion (CG occasion) is less than a first configured offset, for example the first configured offset includes cg-SDT-MaxDurationToNext-CG-Occasion, or the first configured offset includes a time offset different from cg-SDT-MaxDuration ToNext-CG-Occasion;
condition 2, there is no an available random access occasion (RA occasion) between an initiation of the small data transmission (SDT) and the next configured grant occasion (CG occasion) (i.e., there is no available RA occasion until a next CG occasion), or, a time gap between the next configured grant occasion (CG occasion) and an available random access occasion (RA occasion) is less than a second configured offset (wherein a moment of the RA occasion precedes a moment of the CG occasion), in addition, the second configured offset includes cg-SDT-MaxDurationToNext-CG-Occasion, or the second configured offset includes a time offset different from cg-SDT-MaxDuration ToNext-CG-Occasion.

In some embodiments, in the condition 2, if the available random access occasion (RA occasion) is for 2-step random access (2-step RA), the available random access occasion (RA occasion) may be:
a random access occasion for transmitting a random access preamble (RA preamble), for example the random access occasion (RA occasion) is a random access occasion (RA occasion) associated with a first synchronization signal block (SSB), a synchronization signal reference signal received power (SS-RSRP) of the first SSB is higher than a configured second threshold; or
an available physical uplink shared channel occasion (PUSCH occasion), for example the available physical uplink shared channel occasion (PUSCH occasion) is used for transmitting MsgA, and the available physical uplink shared channel occasion (PUSCH occasion) is associated with the available random access occasion (RA occasion); or
a later one of the random access occasion for transmitting the random access preamble (RA preamble) and the available physical uplink shared channel occasion (PUSCH occasion).

In some embodiments, in the condition 2, if the available random access occasion (RA occasion) is for 4-step random access (4-step RA), the available random access occasion (RA occasion) may be: a random access occasion (RA occasion) associated with a second synchronization signal block (SSB), a synchronization signal reference signal received power (SS-RSRP) of the second SSB is higher than a configured third threshold.

In some embodiments, as shown in FIG. 10, the method may further include:
operation 1003, in a case where the predetermined condition in the time domain is not fulfilled, random access-based small data transmission (RA-SDT) is performed or random access is performed.

In operation 1003, that the predetermined condition in the time domain is not fulfilled may include: the condition 2 is not fulfilled; or both the condition 1 and the condition 2 are not fulfilled. In operation 1003, that random access-based small data transmission (RA-SDT) is performed includes: transmitting a resume request message, wherein a resume cause of the resume request message is mobile terminated small data transmission (MT-SDT).

In operation 1003, random access is performed, which may be that legacy random access (legacy RA) is performed, for example including: transmitting a resume request message, wherein a resume cause of the resume request message is mobile terminated access (MT-access).

According to the method in the embodiments of the second aspect, compared with condition 2), operations 1002 and 1003 in the present disclosure utilize condition 2, which is able to respond to paging of a network device more timely.

For example, for the situation A2 of FIG. 9, the RA occasion is before the CG-SDT occasion, which does not fulfill “there is no an available random access occasion (RA occasion) between an initiation of the small data transmission (SDT) and a next configured grant occasion (CG occasion)” in condition 2 of the present disclosure, so according to the embodiments of the second aspect, the terminal equipment may use the RA occasion to perform RA-SDT (unlike performing CG-SDT based on condition 2), thus is able to respond to paging of a network device earlier. For another example, in the situation B1 of FIG. 9, the CG-SDT occasion is before the RA occasion, which fulfils “there is no an available random access occasion (RA occasion) between an initiation of the small data transmission (SDT) and a next configured grant occasion (CG occasion)” in condition 2 of the present disclosure, so the terminal equipment uses the CG-SDT occasion to perform CG-SDT (unlike being unable to perform CG-SDT based on condition 2), thus is able to respond to paging of a network device earlier.

### Embodiments of a Third Aspect

Embodiments of the third aspect of the present disclosure provide an apparatus for performing small data transmission, the apparatus being applicable to a terminal equipment, such as the terminal equipment 102 in FIG. 1. The apparatus corresponds to the method for performing small data transmission in the embodiments of a first aspect.

FIG. 11 is a schematic diagram of an apparatus for performing small data transmission in the embodiments of a third aspect. As shown in FIG. 11, an apparatus 1100 for performing small data transmission includes a first processing unit 1101 configured to control the terminal equipment to enable the terminal equipment to perform the following operations:
initiating small data transmission (SDT); and
performing configured grant-based small data transmission (CG-SDT) in a case where a next valid configured grant occasion (CG occasion) fulfils a predetermined condition in time domain. In some embodiments, the valid configured grant occasion (CG occasion) includes: configured grant (CG) resources configured for the small data transmission (SDT); and/or
a synchronization signal block (SSB) associated with the configured grant (CG) resources is available; and/or
synchronization signal reference signal received power (SS-RSRP) of the synchronization signal block (SSB) associated with the configured grant (CG) resources is above a first configured threshold.

In some embodiments, association between the configured grant (CG) resource and the synchronization signal block (SSB) is configured by a network device.

In some embodiments, the first configured threshold is cg-SDT-RSRP-ThresholdSSB or a reference signal received power (RSRP) threshold that is configured for mobile terminated small data transmission (MT-SDT) and is different from cg-SDT-RSRP-ThresholdSSB.

In some embodiments, the initiating small data transmission (SDT) includes:
a media access control (MAC) layer of the terminal equipment receiving an indication for initiating small data transmission (SDT) from a radio resource control (RRC) layer; or
a upper layer of the terminal equipment indicating initiating small data transmission (SDT); or
a media access control (MAC) layer of the terminal equipment evaluating whether a condition for initiating small data transmission (SDT) is fulfilled; or
a media access control (MAC) layer of the terminal equipment evaluating whether a condition for performing configured grant-based small data transmission (CG-SDT) is fulfilled.

In some embodiments, the fulfilling the predetermined condition in the time domain includes:
a time gap between an initiation of the small data transmission (SDT) and the next valid configured grant occasion (CG occasion) is less than a first configured offset; and/or
there is no an available random access occasion (RA occasion) between an initiation of the small data transmission (SDT) and the next valid configured grant occasion (CG occasion), or, a time gap between the next valid configured grant occasion (CG occasion) and an available random access occasion (RA occasion) is less than a second configured offset.

In some embodiments, the first configured offset includes cg-SDT-MaxDurationToNext-CG-Occasion or a time offset different from cg-SDT-MaxDurationToNext-CG-Occasion.

In some embodiments, the second configured offset includes cg-SDT-MaxDurationToNext-CG-Occasion or a time offset different from cg-SDT-MaxDurationToNext-CG-Occasion.

In some embodiments, the available random access occasion (RA occasion) includes:
a random access occasion for transmitting a random access preamble (RA preamble); or
an available physical uplink shared channel occasion (PUSCH occasion); or
a later one of the random access occasion for transmitting the random access preamble (RA preamble) and the available physical uplink shared channel occasion (PUSCH occasion).

In some embodiments, the available random access occasion (RA occasion) includes:
a random access occasion (RA occasion) associated with a synchronization signal block (SSB) whose synchronization signal reference signal received power (SS-RSRP) is higher than a configured second threshold.

In some embodiments, the available physical uplink shared channel occasion (PUSCH occasion) is associated with the available random access occasion (RA occasion).

In some embodiments, a random access occasion (RA occasion) associated with a synchronization signal block (SSB) whose synchronization signal reference signal received power (SS-RSRP) is higher than a configured third threshold.

In some embodiments, in a case where the predetermined condition is not fulfilled, random access-based small data transmission (RA-SDT) is performed or random access is performed.

In some embodiments, that the random access-based small data transmission (RA-SDT) is performed includes:
transmitting a resume request message, wherein a resume cause of the resume request message is mobile terminated small data transmission (MT-SDT).

In some embodiments, that random access is performed includes:
transmitting a resume request message, wherein a resume cause of the resume request message is mobile terminated access (MT-access).

For further description of the embodiments of the third aspect, description of the relevant contents of the embodiments of the first aspect may be referred to.

### Embodiments of a Fourth Aspect

Embodiments of the fourth aspect of the present disclosure provide an apparatus for performing small data transmission, the apparatus being applicable to a terminal equipment, such as the terminal equipment 102 in FIG. 1. The apparatus corresponds to the method for performing small data transmission in the embodiments of the second aspect.

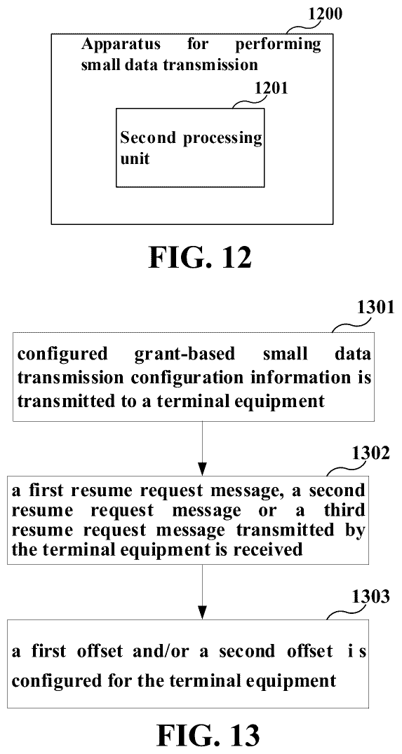

FIG. 12 is a schematic diagram of an apparatus for performing small data transmission in the embodiments of a fourth aspect. As shown in FIG. 12, an apparatus 1200 for performing small data transmission includes a second processing unit 1201 configured to control the terminal equipment to enable the terminal equipment to perform the following operations:
initiating small data transmission (SDT); and
performing configured grant-based small data transmission (CG-SDT) in a case where a next configured grant occasion (CG occasion) fulfils a predetermined condition in time domain, wherein the fulfilling the predetermined condition in the time domain includes:
there is no an available random access occasion (RA occasion) between an initiation of the small data transmission (SDT) and the next configured grant occasion (CG occasion), or, a time gap between the next configured grant occasion (CG occasion) and an available random access occasion (RA occasion) is less than a second configured offset.

In some embodiments, the initiating small data transmission (SDT) includes:
a media access control (MAC) layer of the terminal equipment receiving an indication for initiating small data transmission (SDT) from a radio resource control (RRC) layer; or
a upper layer of the terminal equipment indicating initiating small data transmission (SDT); or
a media access control (MAC) layer of the terminal equipment evaluating whether a condition for initiating small data transmission (SDT) is fulfilled; or
a media access control (MAC) layer of the terminal equipment evaluating whether a condition for performing configured grant-based small data transmission (CG-SDT) is fulfilled.

In some embodiments, the fulfilling the predetermined condition in the time domain further includes:
a time gap between an initiation of the small data transmission (SDT) and the next configured grant occasion (CG occasion) is less than a first configured offset.

In some embodiments, the first configured offset includes cg-SDT-MaxDurationToNext-CG-Occasion or a time offset different from cg-SDT-MaxDurationToNext-CG-Occasion.

In some embodiments, the second configured offset includes cg-SDT-MaxDurationToNext-CG-Occasion or a time offset different from cg-SDT-MaxDurationToNext-CG-Occasion.

In some embodiments, the available random access occasion (RA occasion) includes:
a random access occasion for transmitting a random access preamble (RA preamble); or
an available physical uplink shared channel occasion (PUSCH occasion); or
a later one of the random access occasion for transmitting the random access preamble (RA preamble) and the available physical uplink shared channel occasion (PUSCH occasion).

In some embodiments, the available random access occasion (RA occasion) includes:
a random access occasion (RA occasion) associated with a synchronization signal block (SSB) whose synchronization signal reference signal received power (SS-RSRP) is higher than a configured second threshold.

In some embodiments, the available physical uplink shared channel occasion (PUSCH occasion) is associated with the available random access occasion (RA occasion).

In some embodiments, a random access occasion (RA occasion) associated with a synchronization signal block (SSB) whose synchronization signal reference signal received power (SS-RSRP) is higher than a configured third threshold.

In some embodiments, in a case where the predetermined condition is not fulfilled, random access-based small data transmission (RA-SDT) is performed or random access is performed.

In some embodiments, that the random access-based small data transmission (RA-SDT) is performed includes:
transmitting a resume request message, wherein a resume cause of the resume request message is mobile terminated small data transmission (MT-SDT).

In some embodiments, that random access is performed includes:
transmitting a resume request message, wherein a resume cause of the resume request message is mobile terminated access (MT-access).

For further description of the embodiments of the fourth aspect, description of the relevant contents of the embodiments of the second aspect may be referred to.

### Embodiments of a Fifth Aspect

Embodiments of the fifth aspect of the present disclosure provide a method for performing small data transmission, the method being applicable to a network device, such as the network device 101 in FIG. 1. The apparatus corresponds to the method for performing small data transmission in the embodiments of a first aspect.

FIG. 13 is a schematic diagram of a method for performing small data transmission in the embodiments of a fifth aspect. As shown in FIG. 13, the method includes:
operation 1301, configured grant-based small data transmission configuration information (CG-SDT config) is transmitted to a terminal equipment; and
operation 1302, a first resume request message, a second resume request message or a third resume request message transmitted by the terminal equipment is received.

In operation 1302, a resume cause of the first resume request message is mobile terminated small data transmission (MT-SDT), for example when performing CG-SDT, the terminal equipment transmits the first resume request message to the network device; for another example, the network device may receive the first resume request message on a configured grant occasion (CG occasion).

A resume cause of the second resume request message is mobile terminated small data transmission (MT-SDT), for example when performing RA-SDT, the terminal equipment transmits the second resume request message to the network device; for another example, the network device may receive the second resume request message in a PUSCH occasion indicated by RAR or a PUSCH occasion configured for payload of MSGA.

A resume cause of the third resume request message is mobile terminated access (MT-access), for example when performing random access (such as existing random access), the terminal equipment transmits the third resume request message to the network device.

In some embodiments of operation 1302, the network device may receive the first resume request message on a valid configured grant occasion (CG occasion).

The valid configured grant occasion (CG occasion) includes:
configured grant (CG) resources configured for the small data transmission (SDT); and/or
a synchronization signal block (SSB) associated with the configured grant (CG) resources is available; and/or
synchronization signal reference signal received power (SS-RSRP) of the synchronization signal block (SSB) associated with the configured grant (CG) resources is above a first configured threshold.

The one or more synchronization signal blocks (SSBs) associated with the configured grant (CG) resources may be configured by the network device, for example the network device may configure the one or more synchronization signal blocks (SSBs) associated with the configured grant (CG) resources.

In some embodiments, the first configured threshold is cg-SDT-RSRP-ThresholdSSB or a reference signal received power (RSRP) threshold that is configured for mobile terminated small data transmission (MT-SDT) and is different from cg-SDT-RSRP-ThresholdSSB.

As shown in FIG. 13, the method further includes:

operation 1303, the network device configures a first offset and/or a second offset for the terminal equipment.

The first offset is a parameter of a time gap between an initiation of the small data transmission (SDT) and a next valid configured grant occasion (CG occasion) or a next configured grant occasion (CG occasion); the second offset is a parameter of a time gap between a next valid configured grant occasion (CG occasion) or a next configured grant occasion (CG occasion) and an available random access occasion (RA occasion).

For example, the first offset includes cg-SDT-MaxDurationToNext-CG-Occasion and a time offset different from cg-SDT-MaxDurationToNext-CG-Occasion; the second offset includes cg-SDT-MaxDurationToNext-CG-Occasion and a time offset different from cg-SDT-MaxDurationToNext-CG-Occasion.

### Embodiments of a Sixth Aspect

Embodiments of the sixth aspect of the present disclosure provide an apparatus for performing small data transmission, the apparatus being applicable to a network device, such as the network device 101 in FIG. 1. The apparatus corresponds to the method for performing small data transmission in the embodiments of the fifth aspect.

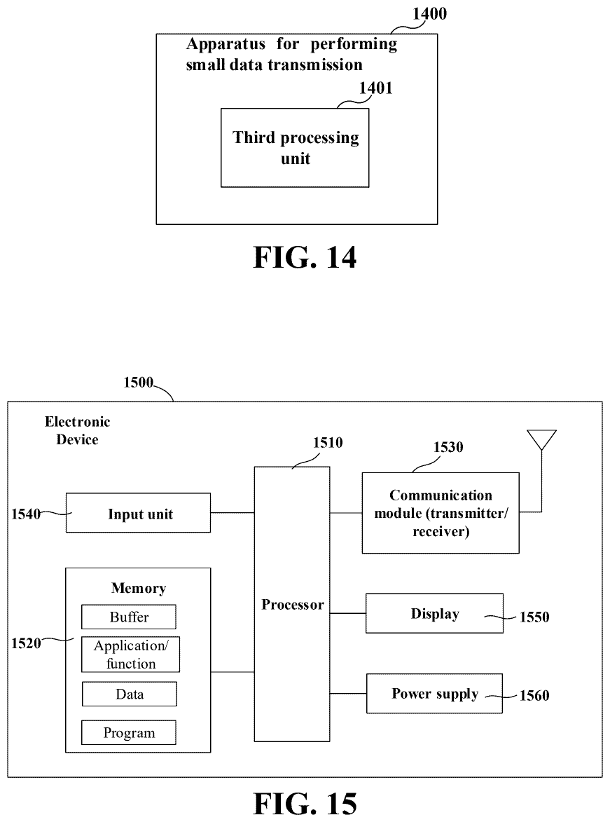

FIG. 14 is a schematic diagram of an apparatus for performing small data transmission in the embodiments of a sixth aspect. As shown in FIG. 14, an apparatus 1400 includes a third processing unit 1401 configured to control a network device to enable the network device to perform the following operations:
transmitting configured grant-based small data transmission configuration information (CG-SDT config) to a terminal equipment; and
receiving a first resume request message, a second resume request message or a third resume request message transmitted by the terminal equipment.

In some embodiments, a resume cause of the first resume request message is mobile terminated small data transmission (MT-SDT), for example when performing CG-SDT, the terminal equipment transmits the first resume request message to the network device; for another example, the network device may receive the first resume request message on a configured grant occasion (CG occasion).

A resume cause of the second resume request message is mobile terminated small data transmission (MT-SDT), for example when performing RA-SDT, the terminal equipment transmits the second resume request message to the network device; for another example, the network device may receive the second resume request message in a PUSCH occasion indicated by RAR or a PUSCH occasion configured for payload of MSGA.

A resume cause of the third resume request message is mobile terminated access (MT-access), for example when performing random access (such as existing random access), the terminal equipment transmits the third resume request message to the network device.

In some embodiments, the network device may receive the first resume request message on a valid configured grant occasion (CG occasion).

The valid configured grant occasion (CG occasion) includes:
configured grant (CG) resources configured for the small data transmission (SDT); and/or
a synchronization signal block (SSB) associated with the configured grant (CG) resources is available; and/or
synchronization signal reference signal received power (SS-RSRP) of the synchronization signal block (SSB) associated with the configured grant (CG) resources is above a first configured threshold.

The one or more synchronization signal blocks (SSBs) associated with the configured grant (CG) resources may be configured by the network device, for example the network device may configure the one or more synchronization signal blocks (SSBs) associated with the configured grant (CG) resources.

In some embodiments, the first configured threshold is cg-SDT-RSRP-ThresholdSSB or a reference signal received power (RSRP) threshold that is configured for mobile terminated small data transmission (MT-SDT) and is different from cg-SDT-RSRP-ThresholdSSB.

In some embodiments, the operations further include: the network device configures a first offset and/or a second offset for the terminal equipment.

The first offset is a parameter of a time gap between an initiation of the small data transmission (SDT) and a next valid configured grant occasion (CG occasion) or a next configured grant occasion (CG occasion); the second offset is a parameter of a time gap between a next valid configured grant occasion (CG occasion) or a next configured grant occasion (CG occasion) and an available random access occasion (RA occasion).

For example, the first offset includes cg-SDT-MaxDurationToNext-CG-Occasion and a time offset different from cg-SDT-MaxDurationToNext-CG-Occasion; the second offset includes cg-SDT-MaxDurationToNext-CG-Occasion and a time offset different from cg-SDT-MaxDuration ToNext-CG-Occasion.

### Embodiments of a Seventh Aspect

Embodiments of a seventh aspect of the present disclosure provide a communication system, the communication system may include a network device and a terminal equipment.

FIG. 15 is a schematic diagram of an electronic device in the embodiments of a seventh aspect. As shown in FIG. 15, the electronic device 1500 may correspond to the terminal equipment 102 or the network device 101 of FIG. 1, the electronic device 1500 may include a processor 1510 and a memory 1520; the memory 1520 stores data and programs, and is coupled to the processor 1510. It's worth noting that this figure is exemplary; other types of structures can also be used to supplement or replace this structure, so as to realize a telecommunication function or other functions.

For example, the processor 1510 may be configured to execute a program to implement at least one of the method in the embodiments of the first aspect, the method in the embodiments of the second aspect and the method in the embodiments of the fourth aspect.

As shown in FIG. 15, the terminal equipment 1500 may further include: a communication module 1530, an input unit 1540, a display 1550 and a power source 1560. The functions of the components are similar to related arts, which are not repeated here. It's worth noting that the terminal equipment 1500 does not have to include all the components shown in FIG. 15, the components are not indispensable. Moreover, the terminal equipment 1500 may further include components not shown in FIG. 15, related arts may be referred to.

Embodiments of the present disclosure further provide a computer program, wherein when a terminal equipment executes the program, the program enables the terminal equipment to execute the method in the embodiments of the first aspect and/or the method in the embodiments of the second aspect.

Embodiments of the present disclosure further provide a storage medium in which a computer program is stored, wherein the computer program enables a terminal equipment to execute the method in the embodiments of the first aspect and/or the method in the embodiments of the second aspect.

Embodiments of the present disclosure further provide a computer program, wherein when a network device executes the program, the program enables the network device to execute the method in the embodiments of the fifth aspect.

Embodiments of the present disclosure further provide a storage medium in which a computer program is stored, wherein the computer program enables a network device to execute the method described in the embodiments of the fifth aspect.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:
Terminal-side method in the embodiments of the first aspect:
1. A method for performing small data transmission, applicable to a terminal equipment, the method including:
initiating small data transmission (SDT); and
performing configured grant-based small data transmission (CG-SDT) in a case where a next valid configured grant occasion (CG occasion) fulfils a predetermined condition in time domain.
2. The method according to supplement 1, wherein,
the valid configured grant occasion (CG occasion) includes:
configured grant (CG) resources configured for the small data transmission (SDT); and/or
a synchronization signal block (SSB) associated with the configured grant (CG) resources is available; and/or
synchronization signal reference signal received power (SS-RSRP) of the synchronization signal block (SSB) associated with the configured grant (CG) resources is above a first configured threshold.
3. The method according to supplement 2, wherein,
association between the configured grant (CG) resource and the synchronization signal block (SSB) is configured by a network device.
4. The method according to supplement 2, wherein,
the first configured threshold is cg-SDT-RSRP-ThresholdSSB or a reference signal received power (RSRP) threshold that is configured for mobile terminated small data transmission (MT-SDT) and is different from cg-SDT-RSRP-ThresholdSSB.
5. The method according to supplement 1, wherein,
initiating the small data transmission (SDT) includes:
a media access control (MAC) layer of the terminal equipment receiving an indication for initiating small data transmission (SDT) from a radio resource control (RRC) layer; or
a upper layer of the terminal equipment indicating initiating small data transmission (SDT); or
a media access control (MAC) layer of the terminal equipment evaluating whether a condition for initiating small data transmission (SDT) is fulfilled; or
a media access control (MAC) layer of the terminal equipment evaluating whether a condition for performing configured grant-based small data transmission (CG-SDT) is fulfilled.
6. The method according to supplement 1, wherein,
fulfilling the predetermined condition in the time domain includes:
a time gap between an initiation of the small data transmission (SDT) and the next valid configured grant occasion (CG occasion) is less than a first configured offset; and/or
there is no an available random access occasion (RA occasion) between an initiation of the small data transmission (SDT) and the next valid configured grant occasion (CG occasion), or, a time gap between the next valid configured grant occasion (CG occasion) and an available random access occasion (RA occasion) is less than a second configured offset.
7. The method according to supplement 6, wherein,
the first configured offset includes cg-SDT-MaxDurationToNext-CG-Occasion or a time offset different from cg-SDT-MaxDurationToNext-CG-Occasion.
8. The method according to supplement 6, wherein,
the second configured offset includes cg-SDT-MaxDurationToNext-CG-Occasion or a time offset different from cg-SDT-MaxDurationToNext-CG-Occasion.
9. The method according to supplement 6, wherein,
the available random access occasion (RA occasion) includes:
a random access occasion for transmitting a random access preamble (RA preamble); or
an available physical uplink shared channel occasion (PUSCH occasion); or
a later one of the random access occasion for transmitting the random access preamble (RA preamble) and the available physical uplink shared channel occasion (PUSCH occasion).
10. The method according to supplement 9, wherein,
the available random access occasion (RA occasion) includes:
a random access occasion (RA occasion) associated with a synchronization signal block (SSB) whose synchronization signal reference signal received power (SS-RSRP) is higher than a configured second threshold.
11. The method according to supplement 9, wherein,
the available physical uplink shared channel occasion (PUSCH occasion) is associated with the available random access occasion (RA occasion).
12. The method according to supplement 6, wherein,
a random access occasion (RA occasion) associated with a synchronization signal block (SSB) whose synchronization signal reference signal received power (SS-RSRP) is higher than a configured third threshold.
13. The method according to supplement 1, wherein,
in a case where the predetermined condition is not fulfilled, performing random access-based small data transmission (RA-SDT) or performing random access.
14. The method according to supplement 13, wherein,
performing the random access-based small data transmission (RA-SDT) includes:
transmitting a resume request message, wherein a resume cause of the resume request message is mobile terminated small data transmission (MT-SDT).
15. The method according to supplement 13, wherein,
performing the random access includes:
transmitting a resume request message, wherein a resume cause of the resume request message is mobile terminated access (MT-access).
Terminal-side method in the embodiments of the second aspect:
1. A method for performing small data transmission, applicable to a terminal equipment, the method including:
initiating small data transmission (SDT); and
performing configured grant-based small data transmission (CG-SDT) in a case where a next configured grant occasion (CG occasion) fulfils a predetermined condition in time domain,
wherein fulfilling the predetermined condition in the time domain includes:
there is no an available random access occasion (RA occasion) between an initiation of the small data transmission (SDT) and the next configured grant occasion (CG occasion), or, a time gap between the next configured grant occasion (CG occasion) and an available random access occasion (RA occasion) is less than a second configured offset.
2. The method according to supplement 1, wherein,
initiating the small data transmission (SDT) includes:
a media access control (MAC) layer of the terminal equipment receiving an indication for initiating small data transmission (SDT) from a radio resource control (RRC) layer; or
a upper layer of the terminal equipment indicating initiating small data transmission (SDT); or
a media access control (MAC) layer of the terminal equipment evaluating whether a condition for initiating small data transmission (SDT) is fulfilled; or
a media access control (MAC) layer of the terminal equipment evaluating whether a condition for performing configured grant-based small data transmission (CG-SDT) is fulfilled.
3. The method according to supplement 1, wherein,
fulfilling the predetermined condition in the time domain further includes:
a time gap between an initiation of the small data transmission (SDT) and the next configured grant occasion (CG occasion) is less than a first configured offset.
4. The method according to supplement 3, wherein,
the first configured offset includes cg-SDT-MaxDurationToNext-CG-Occasion or a time offset different from cg-SDT-MaxDurationToNext-CG-Occasion.
5. The method according to supplement 1, wherein,
the second configured offset includes cg-SDT-MaxDurationToNext-CG-Occasion or a time offset different from cg-SDT-MaxDurationToNext-CG-Occasion.
6. The method according to supplement 3, wherein,
the available random access occasion (RA occasion) includes:
a random access occasion for transmitting a random access preamble (RA preamble); or
an available physical uplink shared channel occasion (PUSCH occasion); or
a later one of the random access occasion for transmitting the random access preamble (RA preamble) and the available physical uplink shared channel occasion (PUSCH occasion).
7. The method according to supplement 6, wherein,
the available random access occasion (RA occasion) includes:
a random access occasion (RA occasion) associated with a synchronization signal block (SSB) whose synchronization signal reference signal received power (SS-RSRP) is higher than a configured second threshold.
8. The method according to supplement 6, wherein,
the available physical uplink shared channel occasion (PUSCH occasion) is associated with the available random access occasion (RA occasion).
9. The method according to supplement 3, wherein,
a random access occasion (RA occasion) associated with a synchronization signal block (SSB) whose synchronization signal reference signal received power (SS-RSRP) is higher than a configured third threshold.
10. The method according to supplement 1, wherein,
in a case where the predetermined condition is not fulfilled, performing random access-based small data transmission (RA-SDT) or performing random access.
11. The method according to supplement 10, wherein,
performing the random access-based small data transmission (RA-SDT) includes:
transmitting a resume request message, wherein a resume cause of the resume request message is mobile terminated small data transmission (MT-SDT).
12. The method according to supplement 10, wherein,
performing the random access includes:
transmitting a resume request message, wherein a resume cause of the resume request message is mobile terminated access (MT-access).

Network device-side Method in the embodiments of the first aspect:
1. A method for performing small data transmission, applicable to a network device, the method including:
transmitting configured grant-based small data transmission configuration information (CG-SDT config) to a terminal equipment; and
receiving a first resume request message, a second resume request message or a third resume request message transmitted by the terminal equipment,
wherein a resume cause of the first resume request message is mobile terminated small data transmission (MT-SDT),
a resume cause of the second resume request message is mobile terminated small data transmission (MT-SDT),
a resume cause of the third resume request message is mobile terminated access (MT-access).
2. The method according to supplement 1, wherein,
the first resume request message is received on a valid configured grant occasion (CG occasion).
3. The method according to supplement 2, wherein,
the valid configured grant occasion (CG occasion) includes:
configured grant (CG) resources configured for the small data transmission (SDT); and/or
a synchronization signal block (SSB) associated with the configured grant (CG) resources is available; and/or
synchronization signal reference signal received power (SS-RSRP) of the synchronization signal block (SSB) associated with the configured grant (CG) resources is above a first configured threshold.
4. The method according to any one of supplements 1 to 3, wherein,
the network device configuring the one or more synchronization signal blocks (SSBs) associated with the configured grant (CG) resource.
5. The method according to supplement 3, wherein,
the first configured threshold is cg-SDT-RSRP-ThresholdSSB or a reference signal received power (RSRP) threshold that is configured for mobile terminated small data transmission (MT-SDT) and is different from cg-SDT-RSRP-ThresholdSSB.
6. The method according to any one of supplements 1 to 5, wherein,
the network device configuring a first offset for the terminal equipment, wherein the first offset is a parameter of a time gap between an initiation of small data transmission (SDT) and a next valid configured grant occasion (CG occasion) or a next configured grant occasion (CG occasion).
6b. The method according to supplement 6, wherein the first configured offset includes cg-SDT-MaxDurationToNext-CG-Occasion or a time offset different from cg-SDT-MaxDuration ToNext-CG-Occasion.
7. The method according to any one of supplements 1 to 5, wherein,
the network device configuring a second offset for the terminal equipment, wherein the second offset is a parameter of a time gap between a next valid configured grant occasion (CG occasion) or a next configured grant occasion (CG occasion) and an available random access occasion (RA occasion).
7b. The method according to supplement 7, wherein the second configured offset includes cg-SDT-MaxDuration ToNext-CG-Occasion or a time offset different from cg-SDT-MaxDurationToNext-CG-Occasion.

What is claimed is:

1. An apparatus for performing small data transmission, applied to a terminal device, the apparatus comprising:
first processor circuitry controlling the terminal device, the first processor circuitry configured to perform:
initiating small data transmission including Mobile Originated SDT or Mobile Terminated SDT by upper layers of the terminal device; and
performing configured grant-based small data transmission when a next valid configured grant occasion fulfils a predetermined condition in the time domain;
wherein a valid configured grant occasion is Configured grant resources configured for the small data transmission and corresponds to a synchronization signal block with synchronization signal reference signal received power above a first configured threshold and the synchronization signal block is available.

2. The apparatus according to claim 1, wherein, the first configured threshold is cg-SDT-RSRP-ThresholdSSB.

3. The apparatus according to claim 1, wherein,
that a next valid configured grant occasion fulfils a predetermined condition in time domain comprises that:
a time gap between an initiation of the small data transmission and a next valid configured grant occasion is less than a first configured value; and/or
there is no available random access occasion between an initiation of the small data transmission and a next valid configured grant occasion, or, a time gap between a next valid configured grant occasion and an available random access occasion is less than a second configured value.

4. The apparatus according to claim 3, wherein,
the available random access occasion, comprises:
a random access occasion for transmitting a random access preamble; or
an available physical uplink shared channel occasion; or
a later one of a random access occasion for transmitting a random access preamble and an available physical uplink shared channel occasion.

5. The apparatus according to claim 1, wherein,
in a case where the predetermined condition is not fulfilled, random access-based small data transmission is performed or random access is performed.

6. The apparatus according to claim 5, wherein,
that the random access-based small data transmission is performed, comprises:
transmitting a resume request message, wherein a resume cause of the resume request message is mobile terminated small data transmission.

7. The apparatus according to claim 5, wherein,
that the random access is performed comprises:
transmitting a resume request message, wherein a resume cause of the resume request message is mobile terminated access.

8. An apparatus for performing small data transmission, applied to a terminal device, the apparatus comprising:
second processor circuitry controlling the terminal device, the second processor circuitry configured to perform:
initiating small data transmission; and
performing configured grant-based small data transmission when a next configured grant occasion fulfils a predetermined condition in the time domain,
wherein, that a next configured grant occasion fulfils a predetermined condition in time domain comprises that:
there is no available random access occasion between an initiation of the small data transmission and the next configured grant occasion, or, a time gap between the next configured grant occasion and an available random access occasion is less than a second configured value.

9. The apparatus according to claim 8, wherein,
the initiating small data transmission comprises that:
a media access control layer of the terminal device receives an indication of initiating small data transmission from a radio resource control layer; or
an upper layer of the terminal device indicates initiating small data transmission; or
a media access control layer of the terminal device evaluates whether a condition for initiating small data transmission is fulfilled; or
a media access control layer of the terminal device evaluates whether a condition for performing configured grant-based small data transmission is fulfilled.

10. The apparatus according to claim 8, wherein,
the that a next configured grant occasion fulfils a predetermined condition in time domain further comprises that:
a time gap between an initiation of the small data transmission and the next configured grant occasion is less than a first configured value.

11. The apparatus according to claim 10, wherein,
the available random access occasion, comprises:
a random access occasion for transmitting a random access preamble; or
an available physical uplink shared channel occasion; or
a later one of the random access occasion for transmitting the random access preamble and the available physical uplink shared channel occasion.

12. The apparatus according to claim 8, wherein,
in a case where the predetermined condition is not fulfilled, performing random access-based small data transmission or performing random access.

13. The apparatus according to claim 12, wherein,
the performing random access-based small data transmission, comprises:
transmitting a resume request message, wherein a resume cause of the resume request message is mobile terminated small data transmission.

14. An apparatus for performing small data transmission, applied to a network device, the apparatus comprising:
third processor circuitry controlling the network device, the third processor circuitry to perform:
transmitting configured grant-based small data transmission configuration information to a terminal device; and
receiving a first resume request message, a second resume request message or a third resume request message transmitted by the terminal device,
wherein, a resume cause of the first resume request message is mobile terminated small data transmission,
a resume cause of the second resume request message is mobile terminated small data transmission, and
a resume cause of the third resume request message is mobile terminated access.

15. The apparatus according to claim 14, wherein,
the network device receives the first resume request message on a valid configured grant occasion.

16. The apparatus according to claim 14, wherein, the operations further comprise that:
the network device configures one or more synchronization signal blocks associated with the configured grant resource.

17. The apparatus according to claim 14, wherein, the operations further comprise:
the network device configures a first value for the terminal device, wherein the first value is a parameter of a time interval between an initiation of small data transmission and a next valid configured grant occasion or a next configured grant occasion.

18. The apparatus according to claim 14, wherein, the operations further comprise:
the network device configures a second value for the terminal device, wherein the second value is a parameter of a time interval between a next valid configured grant occasion or a next configured grant occasion and an available random access occasion.
